(19) United States
(12) Patent Application Publication
(10) Pub. No.: US 2022/0021634 A1
(43) Pub. Date: Jan. 20, 2022

(54) INFORMATION LINKAGE DEVICE, INFORMATION LINKAGE SYSTEM, INFORMATION LINKAGE METHOD, AND PROGRAM

(71) Applicant: Mitsubishi Electric Corporation, Chiyoda-ku, Tokyo (JP)

(72) Inventors: Mai SAKAGAWA, Chiyoda-ku, Tokyo (JP); Hirofumi FURUKAWA, Chiyoda-ku, Tokyo (JP); Yoichiro KOGA, Chiyoda-ku, Tokyo (JP); Keita MORI, Chiyoda-ku, Tokyo (JP)

(73) Assignee: Mitsubishi Electric Corporation, Chiyoda-ku, Tokyo (JP)

(21) Appl. No.: 17/312,424

(22) PCT Filed: Aug. 22, 2019
(86) PCT No.: PCT/JP2019/032747

§ 371 Date: Jun. 10, 2021

(30) Foreign Application Priority Data
Jan. 4, 2019 (JP) PCT/JP2010/000033

(51) Int. Cl. H04L 12/58

(52) U.S. Cl. CPC H04L 51/12; H04L 51/16

(57) ABSTRACT

Provided is an information linkage device for causing information in a chat server that manages chat information to be reflected in an information management system that manages action item information. The information linkage device includes a control unit for analyzing information handled in a chat transmitted/received to and from the chat server via a network and acquiring action item information, and transmitting the action item information to the information management system.

### TECHNICAL FIELD

The present invention relates to an information linkage device, an information linkage system, an information linkage method, and a program, and more particularly, an information linkage device, an information linkage system, an information linkage method, and a program that cause information in a chat server that manages chat information to be reflected in an information management system that manages action item information.

### BACKGROUND ART

Chat, which enables real-time communication, is being used as a tool to promote information sharing between users using computer systems. As an information management technique utilizing such chat, Patent Document 1 discloses a chat summary reference control method for generating edit information by editing a plurality of messages exchanged by using a chat function by referring to a storage unit in which the plurality of messages and a plurality of pieces of sender information that can identify user accounts of senders of the plurality of the messages are stored. The chat summary reference control method of Patent Document 1 provides the edit information only to user accounts included in the plurality of senders. This can control whether or not to disclose contents of actual exchange of messages depending on the user to whom minutes are provided.

### PRIOR ART DOCUMENTS

### Patent Documents

Patent Document 1: Japanese Unexamined Patent Application Publication No. 2015-185107

### SUMMARY OF THE INVENTION

### Problems to Be Solved By the Invention

However, in a case where minutes or a chat log are stored as a text, there is a risk that an action item generated in a chat is not recognized or the action item is forgotten after the chat ends even in a case where the action item is recognized.

The present invention has been made to solve the above problems, and an object of the present invention is to reduce a risk of overlooking an action item generated in a chat by automatically acquiring an action item through analysis of a chat and automatically transmitting the acquired action item to an information management system such as a task management system.

### Means for Solving the Problems

A first aspect of the present invention provides an information linkage device that causes information in a chat server that manages chat information to be reflected in an information management system that manages action item information. The information linkage device includes a control unit that acquires the action item information by analyzing information handled in a chat transmitted and received to and from the chat server via a network and transmits the action item information to the information management system.

A second aspect of the present invention provides an information linkage system including the information linkage device according to the first aspect of the present invention; a chat server that manages chat information transmitted and received to and from the information linkage device; and an information management system that receives action item information extracted from the chat information by the information linkage device and manages the action item information.

A third aspect of the present invention provides an information linkage method for causing information in a chat server that manages chat information to be reflected in an information management system that manages action item information. The information linkage method includes acquiring the action item information by analyzing a chat received from the chat server via a network; and transmitting the action item information to the information management system.

A fourth aspect of the present invention provides a program for causing a control unit to perform the information linkage method according to the third aspect of the present invention.

### Effects of the Invention

According to the present invention, it is possible to reduce a risk of overlooking an action item generated in a chat by automatically acquiring an action item by analyzing a chat and automatically transmitting the acquired action item to an information management system such as a task management system.

### BRIEF DESCRIPTION OF THE DRAWINGS

FIG. 1 is a diagram illustrating a configuration of an information linkage system according to a first embodiment of the present invention.

FIG. 2 is a diagram illustrating a configuration of an APP linkage device according to the first embodiment.

FIG. 3 is a diagram illustrating a configuration of a chat server.

FIG. 4 is a diagram illustrating a configuration of a version control server.

FIG. 5 is a diagram illustrating a configuration of a task management server.

FIG. 6 is a diagram illustrating information stored in a database server according to the first embodiment.

FIG. 7 is a diagram illustrating a chat screen displayed on a display of the APP linkage device.

FIG. 8 is a table illustrating examples of a command that can be executed by being entered in a chat.

FIG. 9 is a flowchart illustrating processing of information included in a chat entered on the APP linkage device.

FIG. 10 is a diagram illustrating a data structure of the database server according to the first embodiment.

FIG. 11 is a diagram illustrating a configuration of an information linkage system according to a second embodiment.

FIG. 12 is a diagram illustrating a configuration of an APP linkage device according to the second embodiment.

FIG. 13 is a diagram illustrating information stored in a database server according to the second embodiment.

FIG. 14 is a diagram illustrating a data structure of the database server according to the second embodiment.

FIG. 15 is a diagram illustrating a data confirmation screen displayed on a display of the APP linkage device.

FIG. 16 is a flowchart illustrating an information processing operation performed by a control unit according to the second embodiment.

FIG. 17 is a flowchart illustrating an information processing operation performed by the control unit according to the second embodiment.

FIG. 18 is a flowchart illustrating an information processing operation performed by the control unit according to the second embodiment.

FIG. 19 is a diagram illustrating a configuration of an APP linkage device according to a third embodiment.

FIG. 20 is a block diagram illustrating a functional configuration of an automatic response unit of FIG. 19.

FIG. 21 is a flowchart illustrating a flow of processing performed by the APP linkage device of FIG. 19.

FIG. 22 is a schematic diagram illustrating a chat screen or a message screen displayed for a user such as a questioner.

FIG. 23 is a schematic diagram illustrating a user interface screen displayed for a respondent.

### EMBODIMENTS OF THE INVENTION

Hereinafter, an analyzer according to embodiments of the present invention will be described with reference to the drawings. In each embodiment, identical elements are given identical reference signs, and repeated description thereof will be omitted.

### First Embodiment

### 1. Configuration

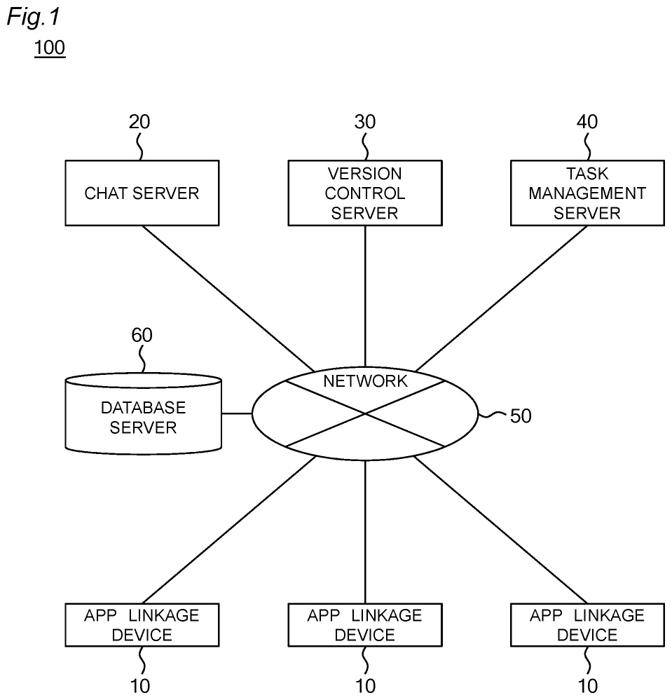

FIG. 1 is a diagram illustrating a configuration of an information linkage system 100 according to a first embodiment of the present invention. The information linkage system 100 is a system for causing various application programs (hereinafter, referred to as “APs”) to operate in cooperation with one another. The information linkage system 100 includes a chat server 20 that manages information related to chat, a version control server 30 that manages information related to software source code versions, a task management server 40 that manages information related to software development tasks, an application program linkage device (APP linkage device) 10 for linking the various APs, and a database server 60. The APP linkage device 10 is realized in a client terminal, and the information linkage system 100 includes a plurality of APP linkage devices 10.

The chat server 20, the version control server 30, the task management server 40, the APP linkage device 10, and the database server 60 are connected via a network 50 and can exchange commands and data with each other via the network 50.

### 1.1 APP Linkage Device

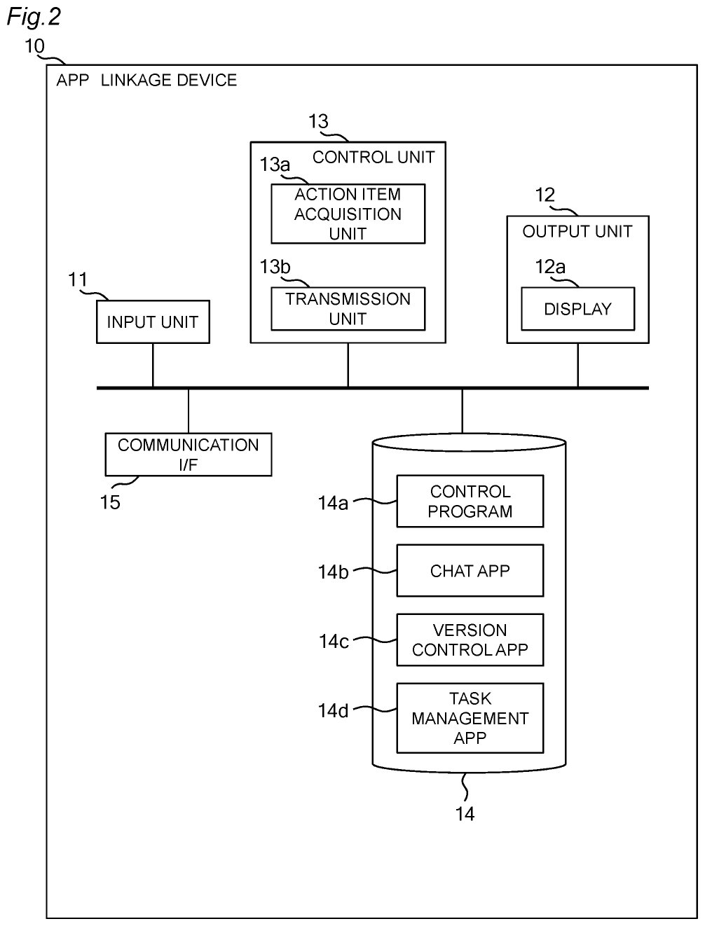

FIG. 2 is a diagram illustrating a configuration of the APP linkage device 10 that constitutes the information linkage system 100. The APP linkage device 10 is an information processing device such as a PC, a tablet, or a smartphone. The APP linkage device 10 includes an input unit 11 that receives information from an outside, an output unit 12 that outputs information to the outside, a control unit 13 that controls overall operation of the APP linkage device 10, a storage unit 14 in which information is stored, and a communication interface (I/F) 15 for connection with the network 50.

The input unit 11 is an input interface that receives an operation instruction given by an operator. For example, the input unit 11 converts an input instruction and contents of an operation received from an operator into an electric signal and transmits the electric signal to the control unit 13. The input unit 11 includes a mouse, a keyboard, a touch panel, a microphone, and the like.

The output unit 12 outputs various information. The output unit 12 includes a display 12a such as a liquid crystal display, an organic EL display, or a projector. Further, the output unit 12 may include a printer (not illustrated) and a speaker that outputs audio.

The control unit 13 includes a general-purpose processor such as a CPU or MPU that realizes a predetermined function by executing a program, and realizes various functions by executing programs 14a to 14d stored in the storage unit 14. The control unit 13 is not limited to one that realizes a predetermined function by cooperation of hardware and software and may be realized by a hardware circuit such as an FPGA, an ASIC, or a DSP designed as a dedicated circuit for realizing a predetermined function.

The storage unit 14 is a recording medium for recording various information. The storage unit 14 is realized, for example, by a semiconductor memory device such as a flash memory or an SSD, a magnetic storage device such as a hard disk, or a storage device of other kinds alone or in combination thereof. The storage unit 14 stores therein a control program 14a that controls the overall operation of the APP linkage device 10 and a chat APP 14b that provides a chat function to a user.

Further, a version control APP 14c is stored in the storage unit 14. The control unit 13 provides a user with a version control function by calling and executing the version control APP 14c. The version control function is realized by a centralized or distributed version control system such as CVS, Subversion, or Git.

Further, a task management APP 14d is stored in the storage unit 14. The control unit 13 provides a user with a task management function by calling and executing the task management APP 14d. The task management function is realized by a task management system such as JIRA (registered trademark) or Redmine.

The communication I/F 15 is an interface circuit for enabling a communication connection to an external device via the network 50. The communication I/F 15 performs the communication according to a standard such as IEEE802.3, IEEE802.11, or Wi-Fi.

### 1.2 Chat Server

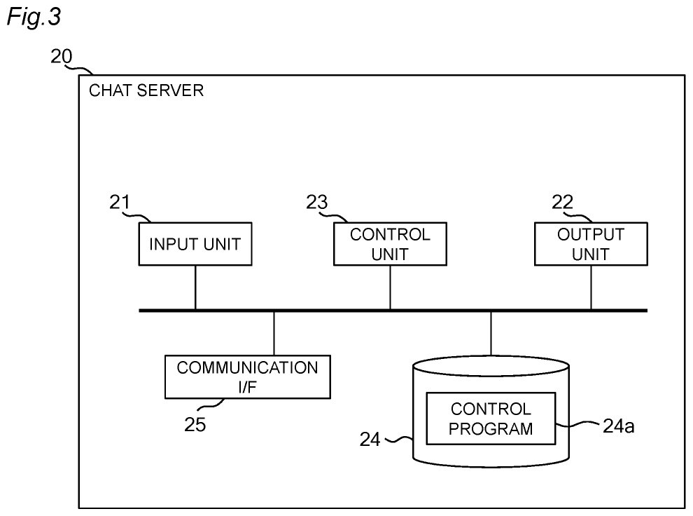

FIG. 3 is a diagram illustrating a configuration of a chat server 20 that constitutes the information linkage system 100. The chat server 20 has a similar configuration to the APP linkage device 10, and is constituted by, for example, one or a plurality of information processing devices. That is, the chat server 20 includes an input unit 21 that receives information from an outside, an output unit 22 that outputs information to the outside, a control unit 23 that controls overall operation of the chat server 20, a storage unit 24 in which information including a control program 24a is stored, and a communication interface (I/F) 25 for connection with the network 50. The chat APP 14b of the APP linkage device 10 and the chat server 20 function as a chat system in cooperation with each other.

### 1.3 Version Control Server

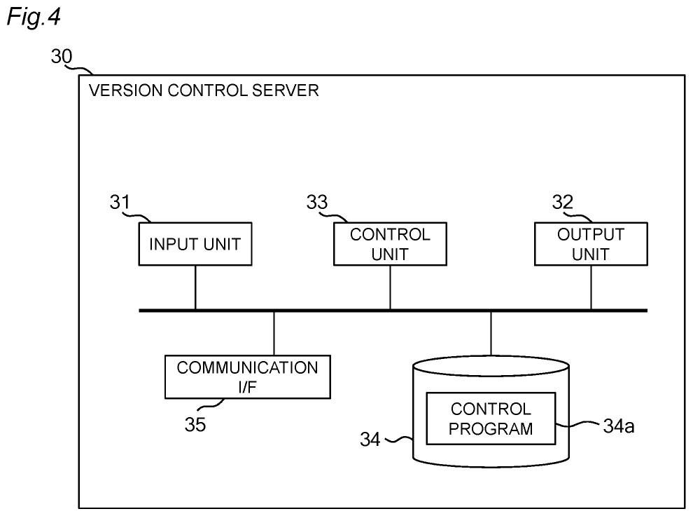

FIG. 4 is a diagram illustrating a configuration of the version control server 30 that constitutes the information linkage system 100. The version control server 30 has a similar configuration to the APP linkage device 10, and is constituted by, for example, one or a plurality of information processing devices. That is, the version control server 30 includes an input unit 31 that receives information from an outside, an output unit 32 that outputs information to the outside, a control unit 33 that controls overall operation of the version control server 30, a storage unit 34 in which information including a control program 34a is stored, and a communication interface (I/F) 35 for connection with the network 50. The version control APP 14c of the APP linkage device 10 and the version control server 30 function as a version control system in cooperation with each other.

### 1.4 Task Management Server

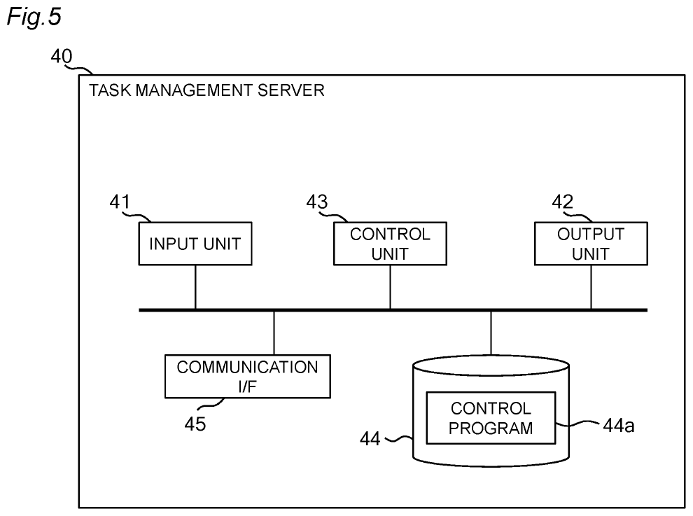

FIG. 5 is a diagram illustrating a configuration of the task management server 40 that constitutes the information linkage system 100. The task management server 40 has a similar configuration to the APP linkage device 10, and is constituted by, for example, one or a plurality of information processing devices. That is, the task management server 40 includes an input unit 41 that receives information from an outside, an output unit 42 that outputs information to the outside, a control unit 43 that controls overall operation of the task management server 40, a storage unit 44 in which information is stored, and a communication interface (I/F) 45 for connection with the network 50. The task management APP 14d of the APP linkage device 10 and the task management server 40 function as a task management system in cooperation with each other.

### 1.5 Database Server

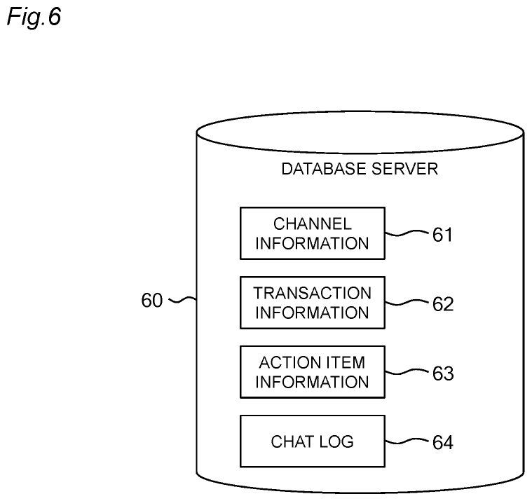

As illustrated in FIG. 6, the database server 60 stores therein information such as channel information 61, transaction information 62, action item information 63, and a chat log 64, which will be described later. The database server 60 may have a similar configuration to the APP linkage device 10.

### 2. Operation

Operation of the information linkage system 100 will be described below.

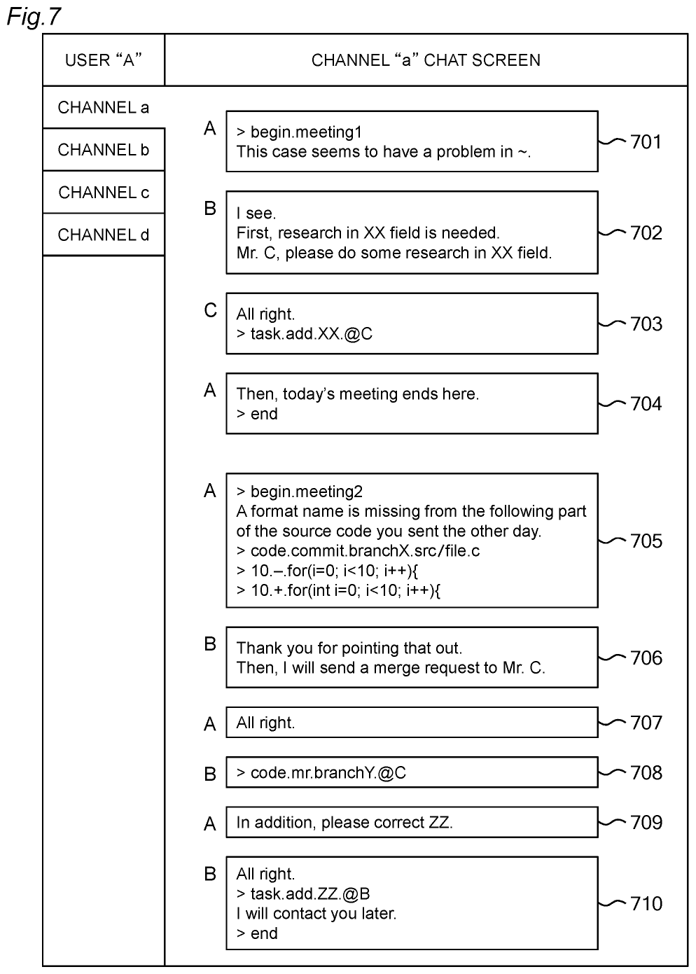

First, a user executes the chat APP 14b by operating the APP linkage device 10, which is a client terminal. The control unit 13 (hereinafter, simply referred to as “chat APP 14b”) that provides a chat function by executing the chat APP 14b accesses the chat server 20 via the network 50. As a result, a chat screen like the one illustrated in FIG. 7 is displayed on the display 12a of the APP linkage device 10.

FIG. 7 illustrates a chat screen which a user A can see. On the chat screen of FIG. 7, comments (chats) 701 to 710 made by users A, B, and C are displayed. The user A can have not only a chat belonging to a channel a illustrated in FIG. 7, but also chats belonging to channels b, c, and d. The channels a to d correspond, for example, to business units such as projects. The user A can switch the chat screen, for example, by clicking any of tabs of the channels a to d in the upper left portion of FIG. 7.

The users A to C can enter not only a conversational sentence, but also a command on the chat screen. The control unit 13 of the APP linkage device 10 interprets a character string entered in a chat, and in a case where the control unit 13 interprets that a command has been entered, operates at least one of the version control APP 14c and the task management APP 14d. This allows the users A to C to operate at least one of the version control APP 14c and the task management APP 14d by entering a command.

In the APP linkage device 10, the channels a to d are managed as metadata for distinguishing pieces of information corresponding to the channels a to d. For example, a log of a chat made in the channel a is stored in a folder or directory dedicated to the channel a. Correspondingly, pieces of information corresponding to the channels a to d are stored in corresponding repositories in the version control APP 14c. For example, in a case where a commit command is designated on the channel a, a correction and a commit is performed on a source code of a repository corresponding to the channel a.

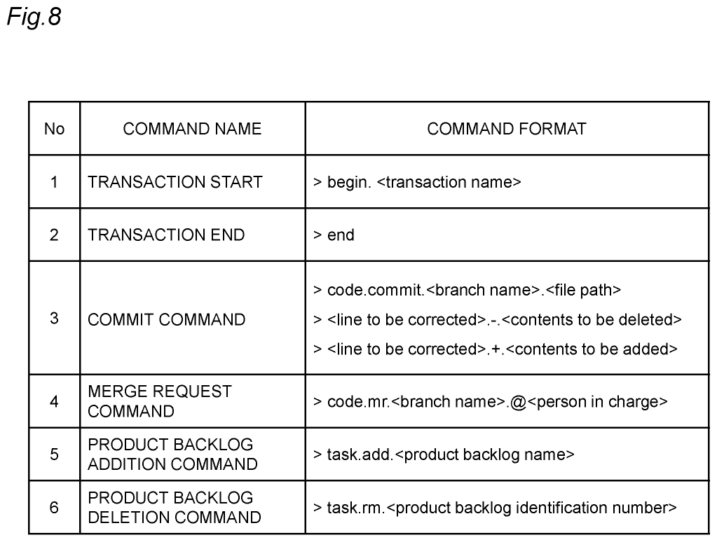

FIG. 8 is a table showing examples of a command that can be executed by being entered in a chat as described above. A transaction start command (command format is “begin.<transaction name>”) and a transaction end command (command format is “end”) in rows No. 1 and No. 2 of the table of FIG. 8 are commands for managing a desired group of chats as a transaction, for example, in accordance with a purpose or contents of the chats. A group of chats from the transaction start command to the transaction end command is managed as one transaction.

In the example illustrated in FIG. 7, a transaction start command “begin.meeting 1” using “meeting 1” as a transaction name is entered in the first line of a chat 701 of the user A. After that, a transaction end command “end” is entered in the second line of a chat 704 of the user A. Accordingly, chats 701 to 704 are managed as a transaction whose transaction name is “meeting 1”. Similarly, a transaction start command “begin.meeting 2” using “meeting 2” as a transaction name is entered in the first line of a chat 705 of the user A. After that, a transaction end command “end” is entered in the fourth line of a chat 710 of the user B. Accordingly, chats 705 to 710 are managed as a transaction whose transaction name is “meeting 2”.

A commit command (command format is “code.commit.<branch name>.<file path>(subsequent lines are omitted)”) in row No. 3 of the table of FIG. 8 is a command for causing the chat APP 14b to send a commit command to the version control APP 14c. Upon receipt of the commit command from the chat APP 14b, the version control APP 14c executes the commit command. The commit command is a command installed as a function of the version control APP 14c and is a command to perform a correction and a commit on a version-controlled source code.

Specifically, when a commit command is entered on the chat APP 14b, the control unit 13 (see FIG. 2) of the APP linkage device 10 that functions as an action item acquisition unit 13a interprets the commit command and acquires contents thereof as an action item. Then, the version control APP 14c reads the contents of the commit command and sends the contents of the commit command to the version control server 30 via the network 50. Upon receipt of the contents of the commit command, the control unit 33 (see FIG. 4) of the version control server 30 sets a branch designated by the commit command as a target branch by checkout, and then executes correction (at least one of deletion and addition) designated by the commit command and executes a commit. In this way, the commit is executed on the version control server 30.

In the example illustrated in FIG. 7, a commit command “code.commit.branchX.src/file.c (line feed)10.−.for(i=0;i<10;i++) {(line feed)10.+.for(int i=0;i<10;i++) {” is entered in the third to fifth lines of the chat 705 of the user A. Therefore, the control unit 13 of the APP linkage device 10 acquires contents of the commit command as an action item. Further, the control unit 13 functioning as a transmission unit 13b transmits the acquired action item to the version control server 30 via the network 50. The control unit 33 of the version control server 30 executes a correction and a commit designated in a file “file.c” under a folder “src” in a branch “branchX” in the repository corresponding to the channel a. That is, the control unit 33 of the version control server 30 deletes “for(i=0;i<10;i++) {” on the 10th line of file.c, adds “for(int i=0;i<10;i++) {” on the 10th line of the same file after the deletion, and commits a result of the correction.

A merge request command (command format is “code.mr.<branch name>.@<person in charge>”) in row No. 4 of the table of FIG. 8 is a command for causing the chat APP 14b to transmit a merge request command to the version control APP 14c. Upon receipt of the merge request command from the chat APP 14b, the version control APP 14c executes the merge request command. The merge request command is a command installed as a function of the version control APP 14c and is a command to transmit a merge request requesting merge of a target branch to a person in charge of merging.

In the example illustrated in FIG. 7, a merge request command “code.mr.branchY.@C” is entered in a chat 708 of the user B. As a result, the control unit 13 of the APP linkage device 10 acquires contents of the merge request command as an action item and transmits the contents of the merge request command to the version control server 30 via the network 50. The control unit 33 of the version control server 30 sends a merge request to C, who is in charge of merging, concerning a branch “branchY”. As a result, a message indicating that the merge request has been received is displayed on a screen of the version control APP 14c which C, who is the person in charge of merging, can see.

A product backlog addition command (command format is “task.add.<product backlog name>”) in row No. 5 of the table of FIG. 8 is a command for causing the chat APP 14b to transmit a product backlog addition command to the task management APP 14d. The task management APP 14d that receives the product backlog addition command executes the product backlog addition command. The product backlog addition command is a command installed as a function of the task management APP 14d and is a command to register a product backlog as a task given a priority level and an identification number of the product backlog.

A product backlog deletion command (command format is “task.rm.product backlog identification number>”) in row No. 6 of the table of FIG. 8 is a command for causing the chat APP 14b to transmit a product backlog deletion command to the task management APP 14d. The task management APP 14d that receives the product backlog deletion command executes the product backlog deletion command. The product backlog deletion command is a command installed as a function of the task management APP 14d and is a command to delete a product backlog specified by an identification number.

In the example illustrated in FIG. 7, a product backlog addition command is entered in the second line (“task.add.XX.@C”) of a chat 703 of the user C and in the second line (“task.add.ZZ.@B”) of the chat 710 of the user B.

The above commands are merely examples, and a command that is installed in the APP linkage device 10 and can be executed by being entered in a chat is not limited to the above commands. For example, commands corresponding to all commands that can be executed in the chat APP 14b, the version control APP 14c, and the task management APP 14d may be installed in the APP linkage device 10 so that the commands can be executed by being entered in a chat.

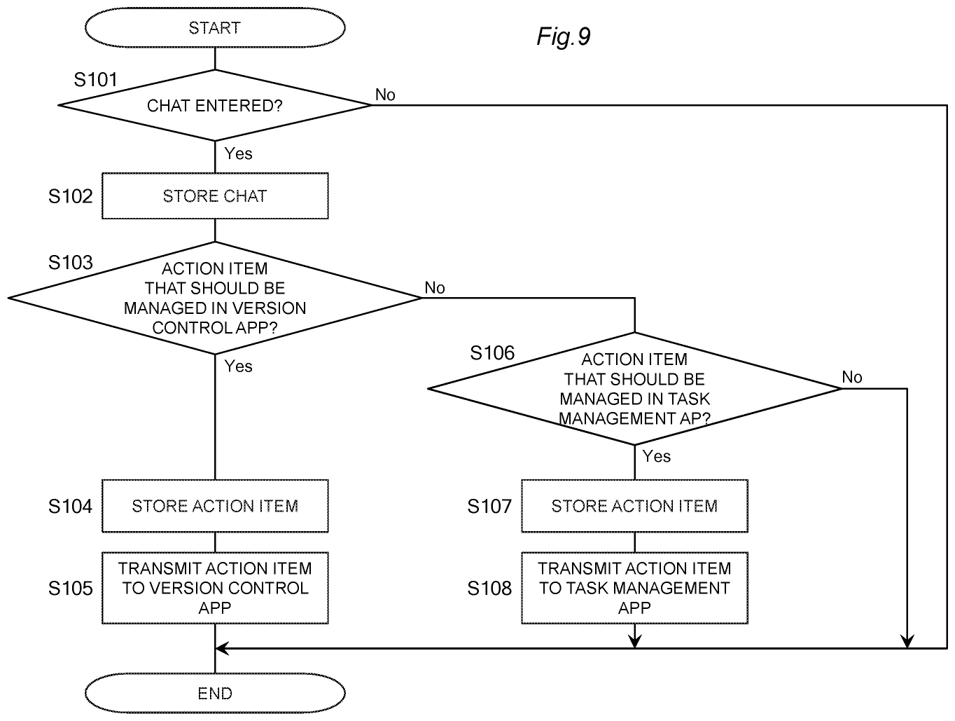

FIG. 9 is a flowchart illustrating processing of information included in a chat entered on the APP linkage device 10. First, when a chat is entered on the chat APP 14b (Yes in S101), the control unit 13 (see FIG. 2) stores the entered chat as a chat log 64 in the database server 60 (S102). In this way, the chat log 64 stores all entered chats regardless of whether or not the entered chats include a command such as an action item.

Next, the control unit 13 of the APP linkage device 10 that functions as an action item acquisition unit 13a (hereinafter, simply referred to as an “action item acquisition unit 13a”) determines whether or not an action item (hereinafter referred to as a “version-controlled action item”) that should be transmitted to and managed in the version control APP 14c has been entered in a chat (S103). In the example illustrated in FIG. 8, the action item acquisition unit 13a determines whether or not a commit command or a merge request command has been entered in a chat.

In a case where it is determined that a version-controlled action item has been entered in a chat (Yes in S103), the control unit 13 stores the entered version-controlled action item in the database server 60 as action item information 63 (see FIG. 6) (S104).

Next, the control unit 13 that functions as the transmission unit 13b transmits the entered version-controlled action item to the version control APP 14c (S105). For example, in a case where a commit command illustrated in FIG. 8 is entered in a chat, the control unit 13 transmits the commit command to the version control APP 14c. Upon receipt of the commit command, the version control APP 14c executes the commit command. Note that the order of step S104 and step S105 is not fixed, and step S104 may be executed after step S105 unlike the above example.

In a case where it is determined in step S103 that a version-controlled action item has not been entered in a chat, the action item acquisition unit 13a determines whether or not an action item (hereinafter referred to as a “task-managed action item”) that should be transmitted to and managed in the task management APP 14d has been entered in a chat (S106). In the example illustrated in FIG. 8, the action item acquisition unit 13a determines whether or not a product backlog addition command or a product backlog deletion command has been entered in a chat.

In a case where it is determined that a task-managed action item has been entered in a chat (Yes in S106), the control unit 13 stores the entered task-managed action item in the database server 60 as action item information 63 (see FIG. 6) (S107).

Next, the control unit 13 functioning as the transmission unit 13b transmits the entered task-managed action item to the task management APP 14d (S108). For example, in a case where a product backlog addition command illustrated in FIG. 8 is entered in a chat, the control unit 13 transmits the product backlog addition command to the task management APP 14d. The task management APP 14d that receives the product backlog addition command executes the product backlog addition command. Note that the order of steps S107 and S108 is not fixed, and step S107 may be executed after step S108 unlike the above example.

The operation (the flow of FIG. 9) for processing information included in a chat is finished in a case where step S105 is finished, in a case where step S108 is finished, in a case where no chat is entered (No in S101), or in a case where it is determined in step S106 that no task-managed action item has been entered in a chat.

The chat stored in step S102 and the action items stored in steps S104 and S107 are stored in association with channel information 61 (see FIGS. 6 and 7) on a channel to which the chat belongs. Further, in a case where a transaction start command is entered in a chat, chats entered before a transaction end command are stored in association with a transaction name.

As an example of a method for associating a chat with a transaction, the chat APP 14b of the APP linkage device 10 associates a chat with a relevant transaction by performing tagging for each of various information (not illustrated) (e.g., superficial information written in the chat or non-superficial information into which the device converts information written in the chat) given to or included in the chat or places relevant chats under a transaction by performing hierarchization. In a case where tagging is performed, for example, tag information (label information) indicative of “meeting 1” is given to a chat log of a chat starting from “begin.meeting 1”. In a case where hierarchization is performed, for example, the chat log of the chat starting from “begin.meeting 1” is stored in a new folder or directory “meeting 1”.

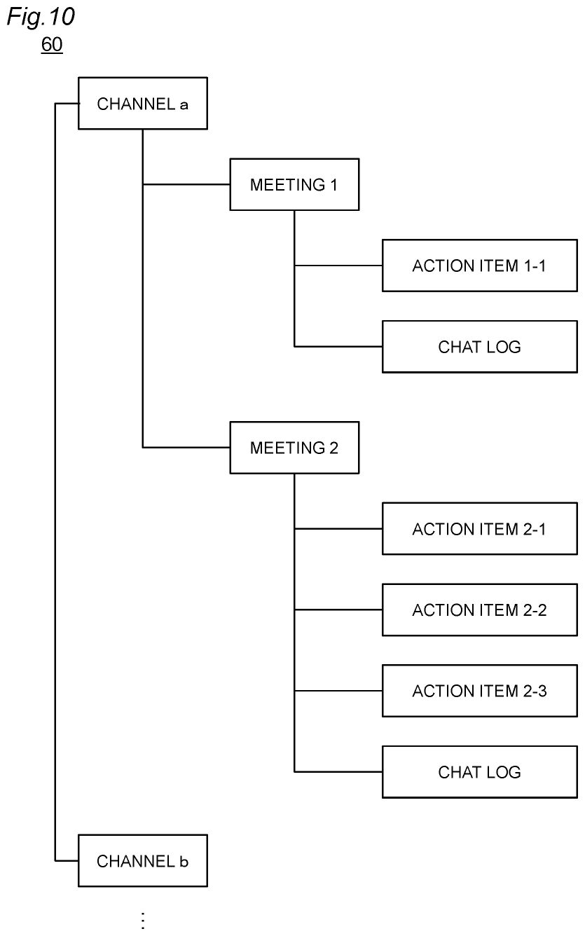

FIG. 10 is a diagram illustrating a data structure of the database server 60. FIG. 10 illustrates an example of a data structure of the database server 60 in which the channel information 61, the transaction information 62, the action item information 63, and the chat log 64 illustrated in FIG. 6 are stored in association with one another. FIG. 10 illustrates a data structure obtained in a case where the chat as illustrated in FIG. 7 is performed. A format of data stored in the database server 60 is, for example, a CSV format, an XML format, or a JSON format.

As illustrated in FIG. 10, the channel information 61 has identification names given to respective channels such as channel a and channel b. Each channel contains transaction information 62.

The transaction information 62 has identification names given to respective transactions. An identification name of a transaction is designated by a transaction start command illustrated in FIG. 8. Since the database of FIG. 10 is made up of the chats as illustrated in FIG. 7, two transactions given identification names “meeting 1” and “meeting 2” are illustrated.

Each transaction contains action item information 63 and chat log 64. The transaction given the identification name “meeting 1” has “action item 1-1” as the action item information 63 based on the chats illustrated in FIG. 7. The “action item 1-1” is an action item declared by the product backlog addition command of the chat 703 in FIG. 7, and includes information such as a product backlog name, which is an argument of the command.

Similarly, in FIG. 10, the transaction having the identification name “meeting 2” has “action item 2-1”, “action item 2-2”, and “action item 2-3” as action item information 63. The “action item 2-1” contains information about the commit command declared in the chat 705 of FIG. 7. The “action item 2-2” contains information about the merge request command declared in the chat 708 in FIG. 7. The “action item 2-3” contains information about the product backlog addition command declared in the chat 710 of FIG. 7.

### 3. Summary

As described above, the first embodiment of the present invention provides the APP linkage device 10 that causes information in the chat server 20 that manages chat information to be reflected in the version control APP 14c or the task management APP 14d that manages the action item information 63. The APP linkage device 10 includes the control unit 13 that acquires action item information by analyzing a chat received from the chat server 20 via the network 50 and transmits the action item information to the version control APP 14c or the task management APP 14d.

With such a configuration, the APP linkage device 10 can automatically acquire an action item by analyzing a chat and automatically transmit the acquired action item to an information management system such as the version control APP 14c and the task management APP 14d. This can reduce a risk that a user overlooks or forgets an action item generated in a chat.

### Second Embodiment

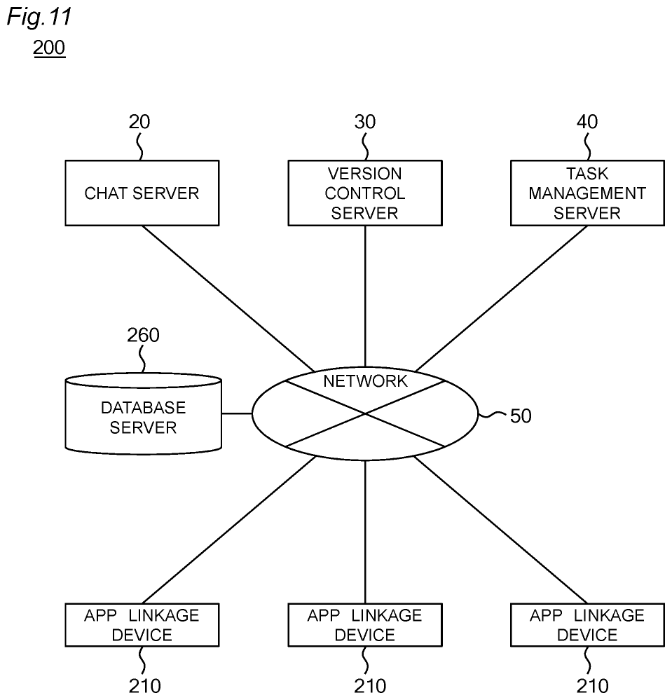

FIG. 11 is a diagram illustrating a configuration of an information linkage system 200 according to the second embodiment. The information linkage system 200 includes a chat server 20, a version control server 30, a task management server 40, an APP linkage device 210, and a database server 260. These devices are connected via a network 50.

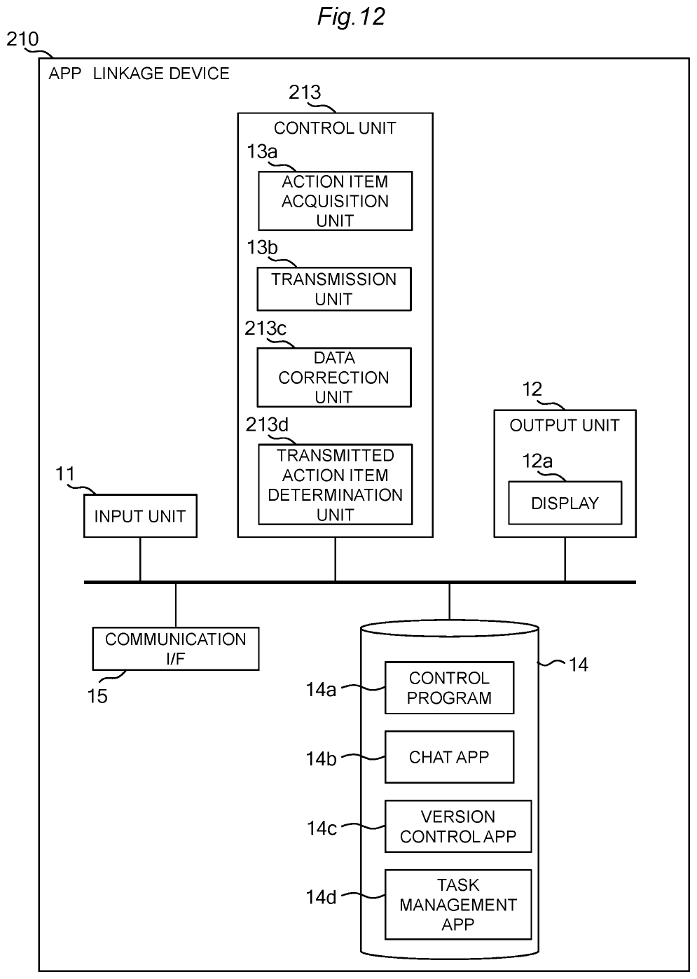

FIG. 12 is a diagram illustrating a configuration of the APP linkage device 210 according to the second embodiment. The APP linkage device 210 is different from the APP linkage device 10 according to the first embodiment in configuration of a control unit 213. That is, the control unit 213 not only functions as an action item acquisition unit 13a and a transmission unit 13b, but also functions as a data correction unit 213c and a transmitted action item determination unit 213d.

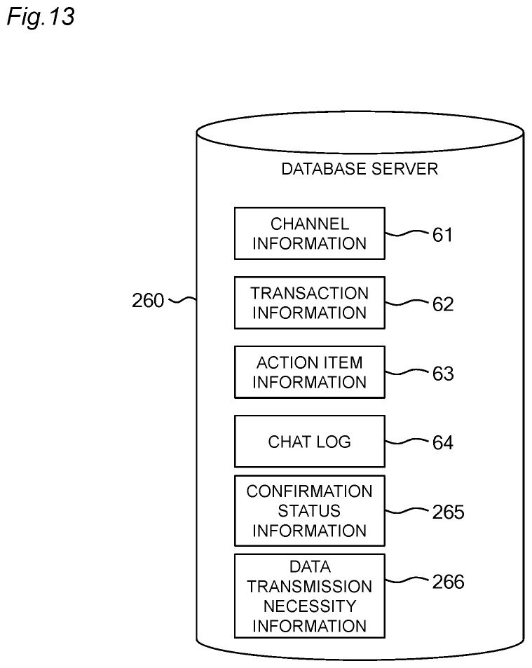

FIG. 13 is a diagram illustrating information stored in the database server 260. Compared with the database server 60 according to the first embodiment, the database server 260 stores therein not only channel information 61, transaction information 62, action item information 63, and a chat log 64, but also confirmation status information 265 and data transmission necessity information 266, which will be described later.

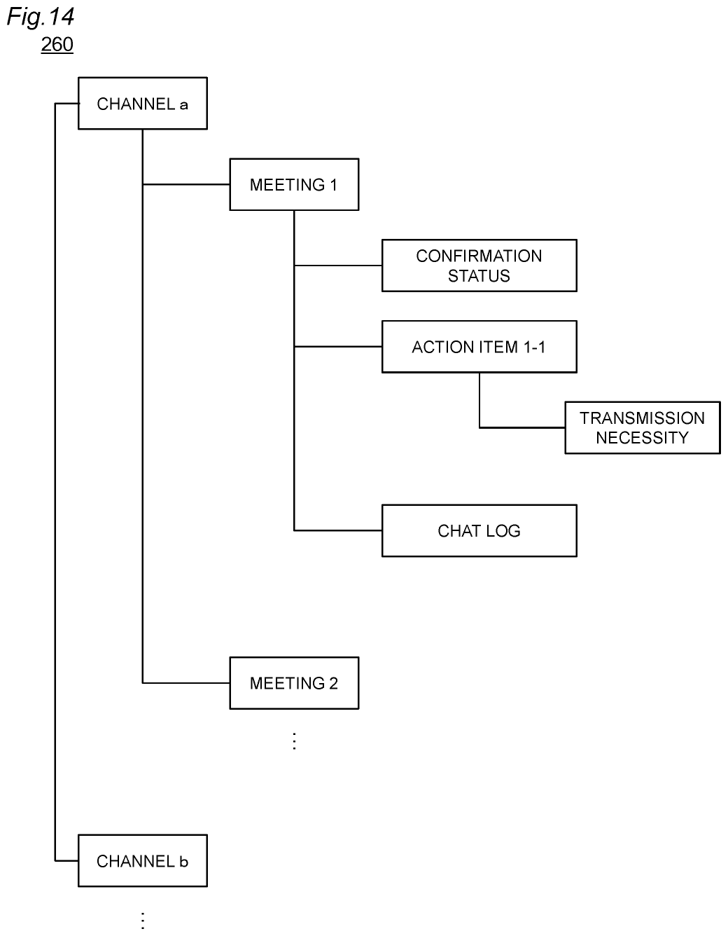

FIG. 14 is a diagram illustrating a data structure of the database server 260. FIG. 14 illustrates an example of a data structure of the database server 260 in which the channel information 61, the transaction information 62, the action item information 63, the chat log 64, the confirmation status information 265, and the data transmission necessity information 266 illustrated in FIG. 13 are stored in association with one another.

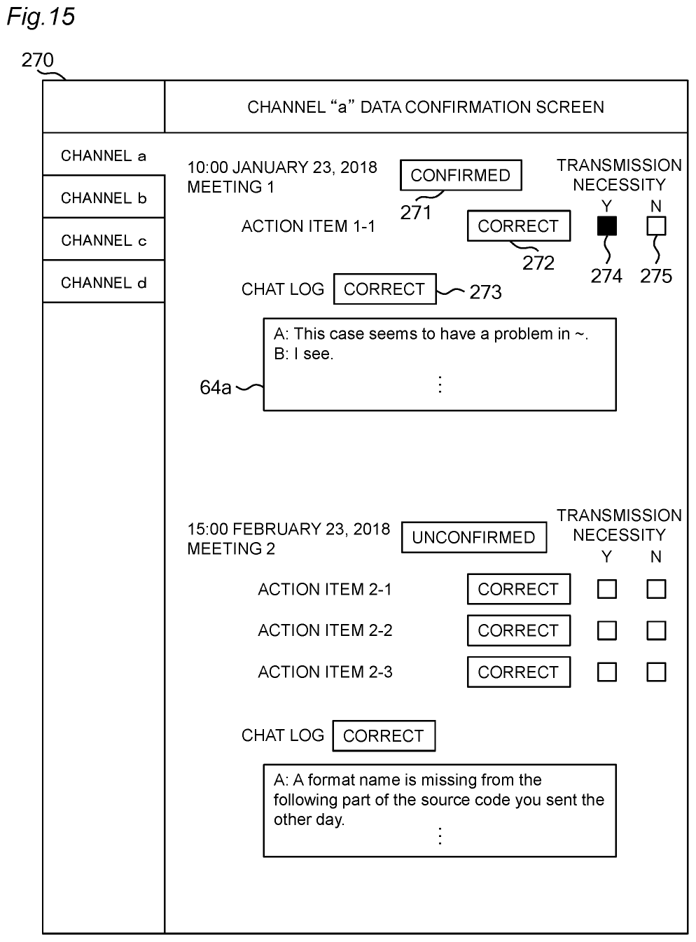

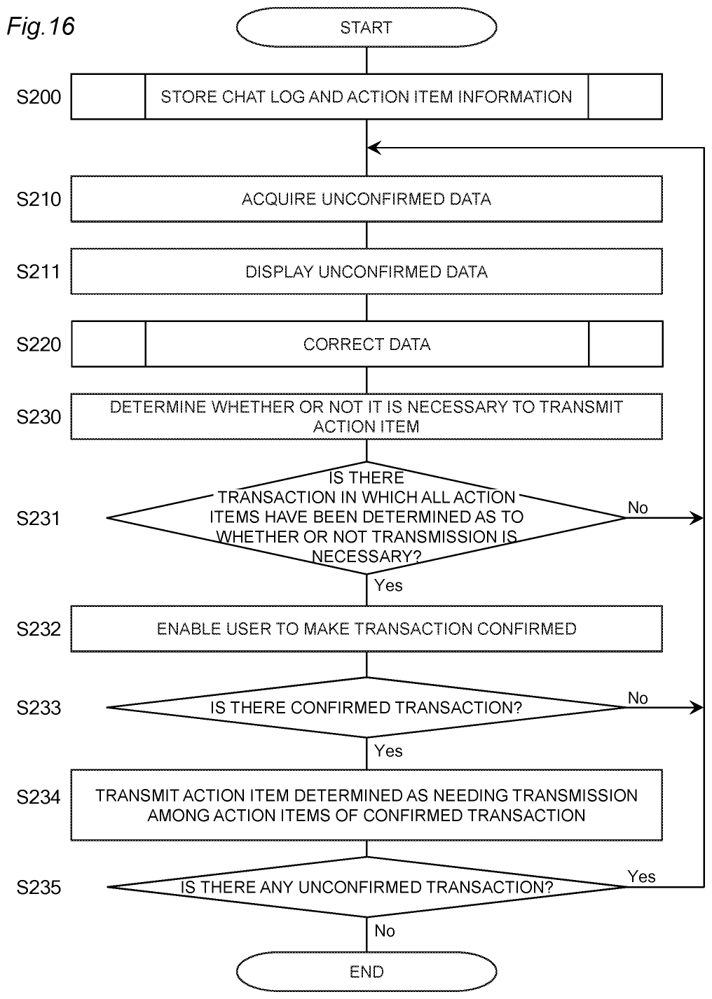

Operations of the data correction unit 213c and the transmitted action item determination unit 213d will be described with reference to FIGS. 15 to 18. FIG. 15 is a diagram illustrating a data confirmation screen 270 displayed on a display 12a of the APP linkage device 10 by the control unit 213. FIGS. 16 to 18 are flowcharts illustrating an information processing operation performed by the control unit 213.

As in the first embodiment, a user executes a chat APP 14b by operating the APP linkage device 10, which is a client terminal, and enters a chat on a chat screen like the one illustrated in FIG. 7. As illustrated in FIG. 16, in response to the entry of the chat by the user, the control unit 213 stores a chat log and action item information in the database server 260 (S200).

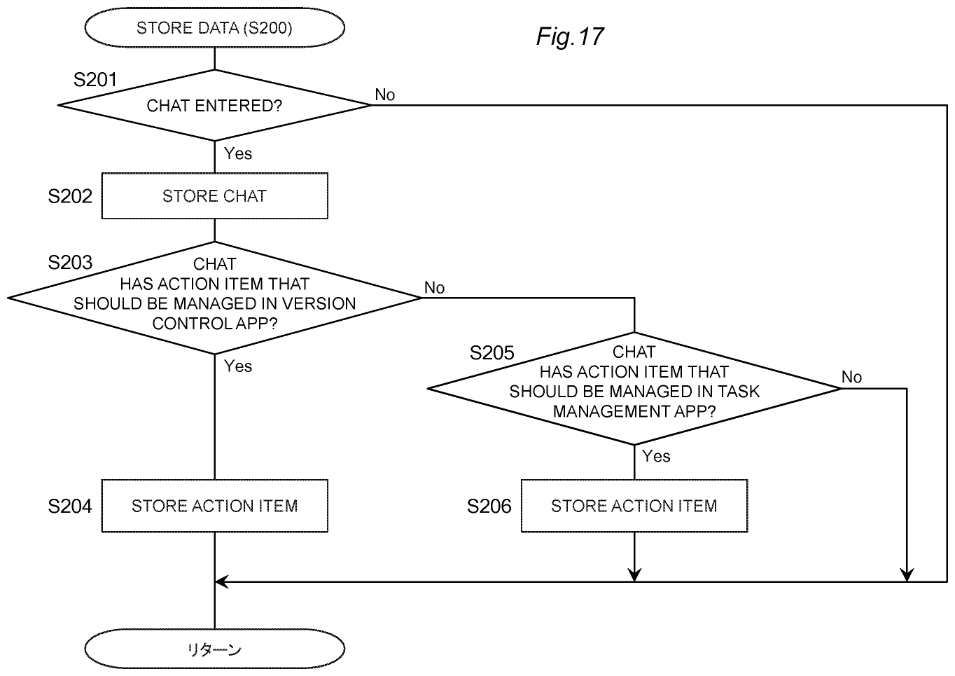

FIG. 17 is a flowchart illustrating a detailed flow of step S200 of FIG. 16. The flow of FIG. 17 is similar to the flow illustrated in FIG. 9 of the first embodiment, but does not include a step of transmitting an action item to a version control APP 14c or a task management APP 14d (steps such as S105 and S108).

That is, first, when a chat is entered on the chat APP 14b (Yes in S201), the control unit 213 stores the entered chat as a chat log 64 in the database server 260 (S202). Next, in a case where it is determined that a version-controlled action item has been entered in the chat (Yes in S203), the action item acquisition unit 13a stores the entered version-controlled action item in the database server 260 as action item information 63 (see FIG. 13) (S204). When step S204 is finished, step S210 in the flowchart of FIG. 16 is performed.

In a case where it is determined in step S203 of FIG. 17 that no version-controlled action item has been entered in the chat, the action item acquisition unit 13a determines whether or not a task-managed action item has been entered in the chat (S205). In a case where it is determined that a task-managed action item has been entered in the chat (Yes in S205), the action item acquisition unit 13a stores the entered task-managed action item as action item information 63 in the database server 260 (S206). When step S206 is finished, step S210 in the flowchart of FIG. 16 is performed.

As illustrated in FIG. 16, the control unit 213, which functions as the data correction unit 213c (see FIG. 12), acquires action item information 63 and a chat log 64 of a transaction that has not been confirmed yet (unconfirmed transaction) from the database server 260 (S210). Whether or not a transaction has been confirmed is determined by a user's operation performed on the data confirmation screen 270 illustrated in FIG. 15 and is stored in the database server 260 as confirmation status information 265 (see FIGS. 13 and 14).

Next, the control unit 213 processes the acquired unconfirmed data in a format that can be displayed on the data confirmation screen 270 (see FIG. 15) and displays the unconfirmed data on the display 12a (see FIG. 12) (S211).

On the data confirmation screen 270 illustrated in FIG. 15, action item information 63 and a chat log 64 are displayed for each transaction. In a part of the data confirmation screen 270 in which a transaction having the identification name “meeting 1” is displayed, “action item 1-1” as action item information 63 and a chat log 64a of “meeting 1” are displayed based on the chats illustrated in FIG. 7. In a part where “action Item 1-1” is displayed, contents of “action Item 1-1” such as a command name and a command argument may be displayed in detail. Alternatively, these details may be displayed when this part is clicked.

When the user confirms the contents displayed on the data confirmation screen 270 and wants to correct the contents of “action Item 1-1”, the user, for example, clicks a button 272 to display a window for entering corrected contents and enters the corrected contents in the window. In a case where the user wants to correct the contents of the chat log 64a, the user, for example, clicks a button 273 to display a window for entering corrected contents and enters the corrected contents in the window.

Returning to FIG. 16, the control unit 213, which functions as the data correction unit 213c, corrects the action item information 63 and the chat log 64 of the database server 260 based on the corrected contents entered by the user as described above (S220).

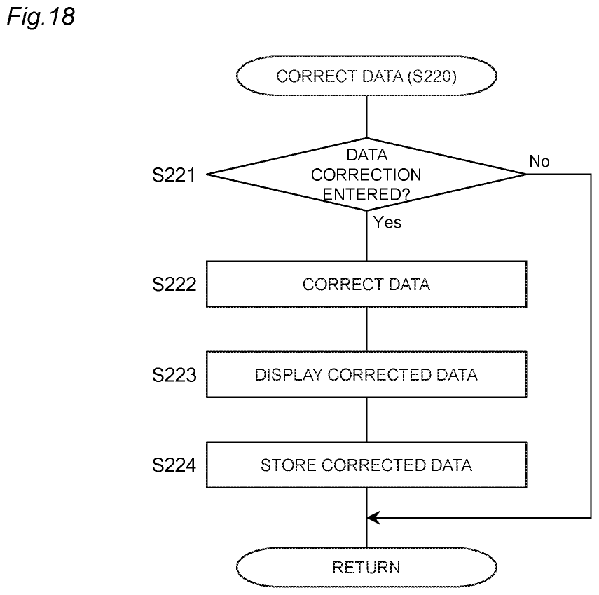

FIG. 18 is a flowchart illustrating a detailed flow of step S220. First, the control unit 213, which functions as the data correction unit 213c, determines whether or not corrected contents of data have been entered by the user (S221). In a case where it is determined that corrected contents of data have not been entered (No in S221), the flow in FIG. 18 is finished, and step S230 in FIG. 16 is performed.

In a case where it is determined in step S221 of FIG. 18 that corrected contents of data have been entered, the control unit 213 functioning as the data correction unit 213c corrects the data, that is, the action item information 63 and the chat log 64 in accordance with the corrected contents (S222). Next, the control unit 213 reflects the corrected data in the data confirmation screen 270 and displays the data confirmation screen 270 reflecting the corrected data on the display 12a (see FIG. 12) (S223). Furthermore, the control unit 213 stores the corrected data in the database server 260 (S224). In the database server 260, the corrected data may be stored separately from the original data or the original data may be overwritten by the corrected data. Note that the order of step S223 and step S224 is not fixed, and step S223 may be executed after step S224 unlike the above example. When the above steps are finished, the flow of FIG. 18 is finished, and step S230 of FIG. 16 is performed.

As illustrated in FIG. 15, the user can decide whether to transmit an action item to the version control APP 14c or the task management APP 14d on the data confirmation screen 270. For example, in a case where the user determines that it is necessary to transmit “action item 1-1”, the user checks a check box 274 indicating that it is necessary to transmit the action item, for example, by clicking the check box 274. On the contrary, in a case where the user determines that it is unnecessary to transmit the action item, the user checks a check box 275 indicating that it is unnecessary to transmit the action item.

Returning to FIG. 16, the control unit 213 functioning as the transmitted action item determination unit 213d (see FIG. 12) determines whether or not it is necessary to transmit each action item based on entry of the user (S230). In step S234, which will be described later, only an action item determined as “needing transmission” in step S230 is transmitted to the version control APP 14c or the task management APP 14d. That is, in step S230, the user selects an action item to be transmitted to the version control APP 14c or the task management APP 14d. In accordance with this selection, the control unit 213 determines an action item to be transmitted to the version control APP 14c or the task management APP 14d from among action items.

Next, the control unit 213 determines whether or not there is a transaction in which all action items have been determined as to whether or not transmission is necessary (S231). In a case where the action items belonging to the transaction includes even one action item that has not been determined as to whether or not transmission is necessary in step S230, the result of step S231 is No, and step S210 is performed.

In a case where there is a transaction in which all action items have been determined as to whether or not transmission is necessary, the control unit 213 enables the user to make the transaction confirmed (S232). In the example illustrated in FIG. 15, the transaction having the identification name “meeting 1” has only one action item, which is determined as “needing transmission”. Therefore, the control unit 213 enables the user to make the transaction having the identification name “meeting 1” confirmed. To enable the user to make the transaction confirmed, the control unit 213, for example, makes a confirmation button 271 appear on the data confirmation screen 270 or makes a confirmation button 271 which is already displayed clickable.

The user makes the transaction confirmed, for example, by clicking the confirmation button 271.

Next, the control unit 213 determines whether or not there is a confirmed transaction (S233). In a case where there is a confirmed transaction, step S234 is performed. In a case where there is no confirmed transaction, step S210 is performed again.

In step S234, the control unit 213 functioning as the transmission unit 13b transmits an action item determined as “needing transmission” in step S230 to the version control APP 14c or the task management APP 14d among action items of the confirmed transaction.

The above steps are repeated until there are no unconfirmed transactions (S235). That is, an unconfirmed transaction continues to be displayed on the data confirmation screen 270.

As described above, the APP linkage device 210 according to the second embodiment includes the transmitted action item determination unit 213d that determines whether or not it is necessary to transmit action item information 63 to the version control APP 14c or the task management APP 14d based on user's entry. The control unit 213 transmits only action item information 63 determined as “needing transmission” to the version control APP 14c or the task management APP 14d.

With such a configuration, the user can confirm the appropriateness of action item information 63 before the action item information 63 is transmitted to an external system such as the version control APP 14c or task management APP 14d. This can prevent a situation where the action item information 63 is transmitted without confirmation and development proceeds in accordance with an action item different from recognition of the user or meeting participants at the time of the meeting.

Further, in the APP linkage device 210, since such confirmation of the action item information 63 can be performed for each transaction, a risk of the user overlooking the information can be reduced, and the action item information 63 can be more easily managed.

### Third Embodiment

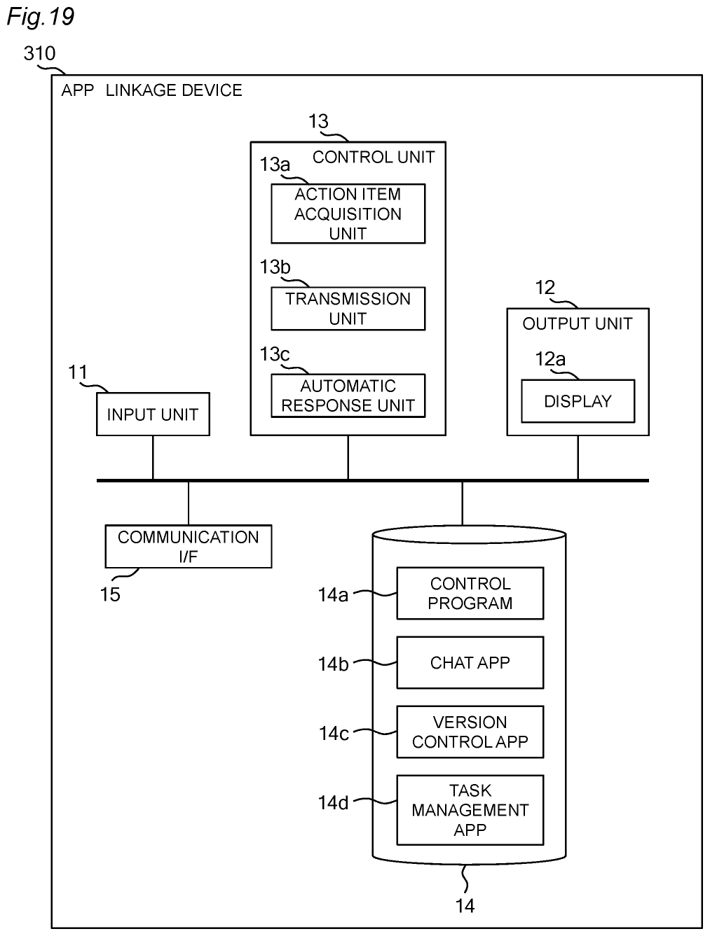

FIG. 19 is a diagram illustrating a configuration of an APP linkage device 310 according to the third embodiment. In the above embodiments, in a case where a command is included in a chat entered by a user, an action item is registered in another system corresponding to the command.

In a case where chat communication becomes active, a flow of chats becomes fast, and multiple topics proceed in parallel. Therefore, a respondent sometimes cannot recognize an inquiry. Meanwhile, in a case where chat communication becomes active, an inquiry about an action item similar to those already appearing in past chats is often made many times. Therefore, an automatic response technology that automatically or semi-automatically generates a response to a message on a chat server is attracting attention.

Known examples of the automatic response technology for responding to entered information include a technology for separating a chat thread into threads for respective channels, a technology for estimating and giving a most appropriate response to entered information such as an inquiry among a plurality of response patterns prepared in advance, and a technology for inferring contents of chats and mechanically generating a plausible response.

However, according to the conventional automatic response technologies, it is difficult to mechanically generate a response that can be established as a conversation although it is possible to prevent overlooking of a message and delay in response by mechanically generating a response and automatically giving the response.

By using the automatic response, the APP linkage device 310 according to the present embodiment can reduce, for example, the burden on a respondent and overlooking even in a situation where a plurality of chats are going on.

A configuration and functions of the APP linkage device 310 will be described below.

FIG. 19 is a diagram illustrating a configuration of an APP linkage device 310 according to the third embodiment. Compared with the APP linkage device 10 of FIG. 2, a control unit 13 of the APP linkage device 310 further includes an automatic response unit 13c that automatically or semi-automatically generates a response to a message on a chat server.

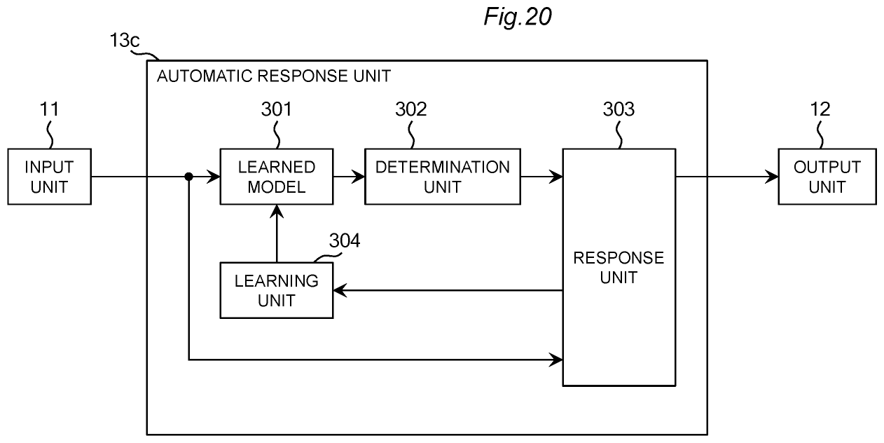

FIG. 20 is a block diagram illustrating a functional configuration of the automatic response unit 13c of FIG. 19. The automatic response unit 13c includes a learned model 301, a determination unit 302, a response unit 303, and a learning unit 304.

The learned model 301 is a model machine-learned to output candidates of a response to an inquiry upon receipt of chat information including an inquiry. For example, the learning unit 304 performs machine learning on a model (learning algorithm) such as a convolutional neural network (CNN) to generate the learned model 301. An example of the machine learning is supervised learning for learning a relationship between an inquiry message entered by a user using an input unit 11 and information indicating a response to the message by using teacher data prepared in advance. Supervised learning of a model such as a CNN is performed by the learning unit 304, for example, by using a backpropagation method. Unlike the example illustrated in FIG. 19, the learned model 301 may be stored in a storage unit 14 and executed by the control unit 13.

A message is input to the learned model 301 by a user by using the input unit 11. The learned model 301 outputs, to the determination unit 302, response candidate information indicating candidates of a response to the input message and plausibility information indicating a degree of appropriateness (plausibility) of the candidates of the response. The plausibility information may be normalized so as to have a value between 0 and 1. The learned model 301 may derive a plausible response by calculating a degree of relevance between input information and response information from a response pattern list in response to an inquiry message, for example, regarding action item information input from the input unit 11.

The inquiry message may be one of the action item information.

The determination unit 302 interprets the response candidate information and the plausibility information received from the learned model 301. In a case where plausibility of a candidate of the response is equal to or higher than a predetermined threshold value, the determination unit 302 outputs this candidate as a response to the response unit 303. Meanwhile, in a case where plausibility of a candidate of the response is less than the predetermined threshold value, the determination unit 302 outputs the candidate to the response unit 303.

The response unit 303 is a processing unit that selects a destination to which input information is to be output, and responds to the content spoken in the chat based on determination by the determination unit 302. In a case where the response unit 303 receives a response from the determination unit 302, the response unit 303 outputs the response to the output unit 12. The response is displayed on a display 12a of the output unit 12. As a result, a respondent can confirm the response. Next, the respondent inputs judgment on the confirmed response to the automatic response unit 13c by using the input unit 11. The judgment result input by the respondent is input to the learned model 301 and the response unit 303.

In a case where the response unit 303 receives a response candidate from the determination unit 302, the response unit 303 outputs the response candidate to the output unit 12. The response candidate is displayed on the display 12a of the output unit 12. As a result, the respondent can confirm the response candidate. Next, the respondent inputs judgment on the confirmed response candidate to the automatic response unit 13c by using the input unit 11. For example, the respondent selects one of the confirmed response candidates as a response and inputs the selected response to the automatic response unit 13c by using the input unit 11. The judgment result input by the respondent is input to the learned model 301 and the response unit 303.

The response unit 303 outputs a response reflecting the judgment result of the respondent to the output unit 12 and the learning unit 304. However, a response that has been determined as a plausible response by the determination unit 302 and has been already output to the respondent does not need to be output to the output unit 12.

As described above, the learning unit 304 learns a relationship between an inquiry message input by a user by using the input unit 11 and a result of judgment on the message by a respondent. The learning unit 304 updates the learning model by sequentially learning a relationship between an inquiry message, for example, regarding action item information and a result of judgment by a respondent by using the result of judgment input to the response unit 303.

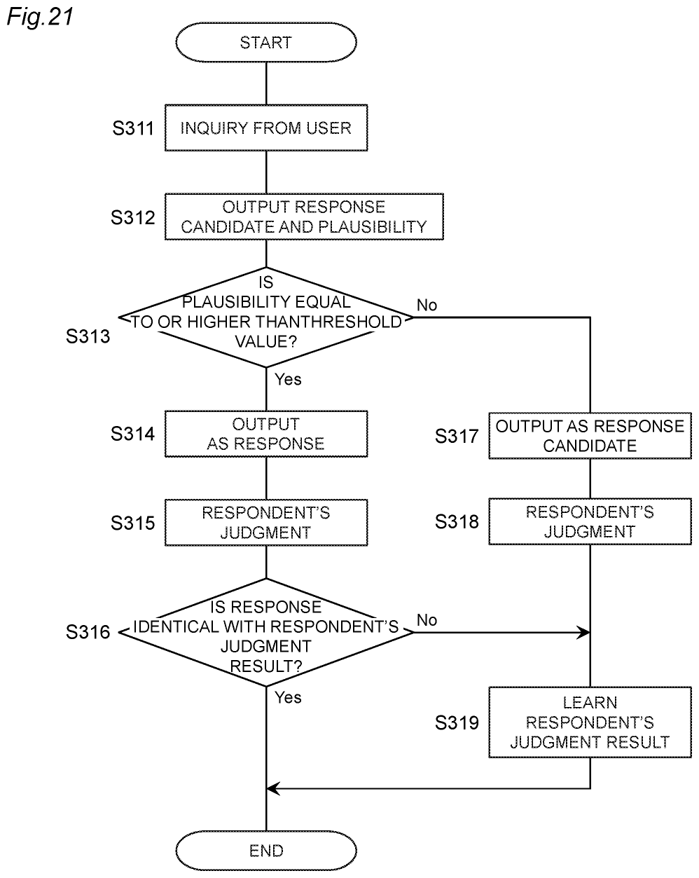

FIG. 21 is a flowchart illustrating a flow of processing performed by the APP linkage device 310.

First, a user inputs a message including an inquiry to the learned model 301 by using the input unit 11 (S311). The learned model 301 outputs, to the determination unit 302, the response candidate information indicating a candidate of a response to the input message and plausibility information indicating appropriateness of the response candidate (S312).

The determination unit 302 determines whether or not the plausibility of the response candidate is equal to or higher than a predetermined threshold value (S313). The predetermined threshold value is preset, for example, to a value such as 0.5 or 0.8. In a case where the plausibility of the response candidate is equal to or higher than the predetermined threshold value (Yes in S313), the determination unit 302 outputs the response candidate as a response to the response unit 303, and the response unit 303 outputs the response to the output unit 12 (S314). In a case where there are a plurality of response candidates whose plausibility is equal to or higher than the predetermined threshold value, the determination unit 302 may output the plurality of response candidates to the response unit 303, and the response unit 303 may output the plurality of response candidates to the output unit 12.

A respondent confirms the response displayed on the display 12a of the output unit 12, and inputs judgment on the confirmed response to the response unit 303 by using the input unit 11 (S315). The response unit 303 determines whether or not the response input in step S314 and a result of the judgment of the respondent input in step S315 are identical (S316). In a case where the response input in step S314 and the result of the judgment of the respondent input in step S315 are not identical (No in S316), the response unit 303 outputs the result of the judgment of the respondent to the learning unit 304, and the learning unit 304 learns the result of the judgment (S319). In a case where there are a plurality of response candidates whose plausibility is equal to or higher than the predetermined threshold value in step S313, the respondent may select one of the response candidates displayed on the display 12a of the output unit 12 as a response and input the selected response to the response unit 303 by using the input unit 11.

In a case where the plausibility of the response candidate is less than the predetermined threshold value (No in S313), the determination unit 302 outputs the response candidate to the response unit 303, and the response unit 303 outputs the response candidate to the output unit 12 (S317). The respondent confirms the response candidate displayed on the display 12a of the output unit 12 and inputs judgment on the confirmed response candidate to the response unit 303 by using the input unit 11 (S318). In step S318, for example, the respondent selects one of the response candidates displayed on the display 12a as a response and inputs the selected response to the response unit 303 by using the input unit 11. The response unit 303 outputs the result of the judgment of the respondent to the learning unit 304, and the learning unit 304 learns the result of the judgment (S319).

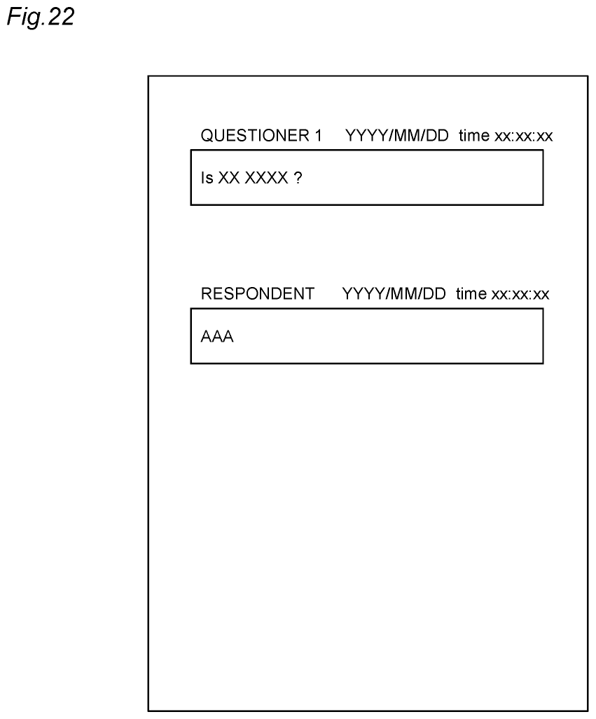

FIG. 22 is a schematic diagram illustrating a chat screen or a message screen displayed to a user such as a questioner. On the screen displayed for the questioner, a question message given by the questioner and a response message given by the respondent are displayed. Although the response message is sometimes automatically generated and transmitted by the automatic response unit 13c of the APP linkage device 310 used by the respondent, whether or not the response message is one automatically generated and transmitted is indistinguishable from the questioner's screen of FIG. 22.

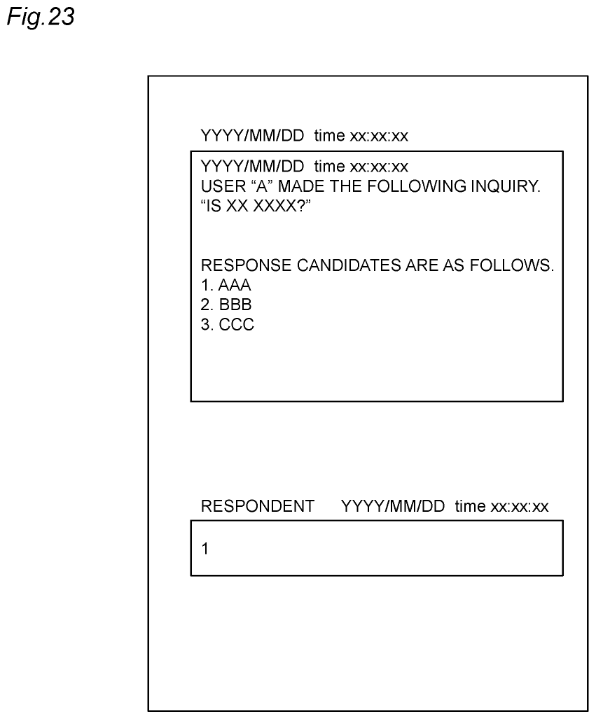

FIG. 23 is a schematic diagram illustrating a user interface screen including a chat screen or a message screen displayed for the respondent. For example, the questioner uses one APP linkage device 310, and the respondent uses another APP linkage device 310 (see FIG. 1 illustrating the APP linkage devices 10). On the user interface screen displayed for the respondent, an inquiry from the questioner and candidates of a response to the inquiry are displayed. The respondent can select a response which the respondent thinks is most appropriate from among the response candidates by using the input unit 11 such as a mouse, a keyboard, or a touch panel.

As described above, the APP linkage device 310 entrusts selection of a response or a response to the respondent, who is a person, in a case where plausibility of a response or a response candidate to an inquiry is less than a predetermined threshold value. As a result, the APP linkage device 310 can give a natural response to the questioner as if a person has given the response. Therefore, it is possible to prevent the questioner from noticing that the respondent with whom the questioner is having a conversation is a machine. This can prevent a questioner who does not want to be responded by a machine from being offended. In addition, the APP linkage device 310 can support responding work of the respondent by automatically responding to an inquiry. This allows a small number of respondents to maintain a large number of conversations in a large-scale chat system.

In the present embodiment, the APP linkage device 310 automatically responds in a case where an inquiry from a questioner is included in a chat by using the chat server 20 (see FIG. 1) and the chat APP 14b (see FIG. 19). However, the present invention is not limited to this. For example, communication of information including a conversation between a questioner and a respondent may be performed between a terminal such as a PC, a tablet, or a smartphone used by the questioner and a terminal used by the respondent without a server interposed therebetween.

In the present embodiment, the determination unit 302 that determines whether or not plausibility of a response candidate is equal to or higher than a predetermined threshold value in S313 has been described. However, the present invention is not limited to this. For example, the determination unit 302 may output the most plausible response candidate among a plurality of response candidates to the response unit 303 as a response.

### DESCRIPTION OF REFERENCE SYMBOLS

10 APPLICATION PROGRAM LINKAGE DEVICE (INFORMATION LINKAGE DEVICE)
11 INPUT UNIT
12 OUTPUT UNIT
12a DISPLAY
13 CONTROL UNIT
14 STORAGE UNIT
15 COMMUNICATION INTERFACE
20 CHAT SERVER
30 VERSION CONTROL SERVER
40 TASK MANAGEMENT SERVER
50 NETWORK
60 DATABASE SERVER
61 CHANNEL INFORMATION
62 TRANSACTION INFORMATION
63 ACTION ITEM INFORMATION
64 CHAT LOG
100 INFORMATION LINKAGE SYSTEM

1. An information linkage device that causes information in a chat server that manages chat information to be reflected in an information management system that manages action item information, the information linkage device comprising:
a control unit that manages a desired separation in a chat, which is to be transmitted and received to and from the chat server via a network, by associating the desired separation with a transaction and that acquires the action item information by analyzing information handled in the chat and transmits the action item information to the information management system.

2. The information linkage device according to claim 1, wherein
the control unit associates the action item information to be transmitted to the information management system with a corresponding transaction.

3. The information linkage device according to claim 1, further comprising an input unit that receives information entered by a user,
wherein the control unit decides action item information to be transmitted to the information management system from among the action item information based on the entered information and transmits the decided action item information to the information management system.

4. (canceled)

5. The information linkage device according to claim 3, wherein the control unit transmits action item information decided for each of the transactions based on the entered information to the information management system.

6. The information linkage device according to claim 1, wherein the control unit manages one or more channels handled as a repository in the information management system and the chat including the action item information associated with the transaction in association with each other.

7. The information linkage device according to claim 6, wherein
the channel is generated for each project, which is a business unit in software development,
the transaction is generated for each meeting in the project, and
the control unit transmits the action item information to the information management system for each of the meetings.

8. The information linkage device according to claim 1, wherein the action item information includes information indicating a task of software development.

9. The information linkage device according to claim 1, wherein the action item information includes information for executing version control of a source code.

10. The information linkage device according to claim 9, wherein the version control includes execution of at least one of a correction and a commit of the source code.

11. An information linkage device comprising:
a control unit that transmits and receives chat information via a network; and
a display that displays the chat information,
wherein
the control unit includes an automatic response unit that automatically generates a response candidate to the received chat information and plausibility of the response candidate, and
the control unit causes the response candidate to be displayed on the display in accordance with the plausibility.

12. The information linkage device according to claim 11, wherein the control unit causes the response candidate to be displayed on the display as a response in a case where the plausibility of the response candidate is equal to or higher than a predetermined threshold value and causes the response candidate to be displayed on the display as a response candidate in a case where the plausibility of the response candidate is less than the predetermined threshold value.

13. The information linkage device according to claim 11, wherein the automatic response unit generates a response candidate to received chat information including an inquiry by using a learned model that has been machine-learned to output a response candidate to the inquiry upon receipt of chat information including the inquiry.

14. The information linkage device according to claim 11, further comprising an input unit used to select and enter a response from among the response candidates,
wherein the control unit causes the display to display a user interface for allowing a person to select a response from among the response candidates, and the automatic response unit updates the learned model by learning the response selected by using the input unit.

15. An information linkage system comprising:
the information linkage device according to claim 1;
a chat server that manages chat information transmitted and received to and from the information linkage device; and
an information management system that receives action item information extracted from the chat information by the information linkage device and manages the action item information.

16. An information linkage method for causing information in a chat server that manages chat information to be reflected in an information management system that manages action item information, the information linkage method comprising:
acquiring the action item information by analyzing a chat received from the chat server via a network; and
transmitting the action item information to the information management system.

17. The information linkage method according to claim 16, further comprising deciding action item information to be transmitted to the information management system from among the action item information based on an entry by a user,
wherein the transmitting is transmitting the decided action item information to the information management system.

18. An information linkage method in which a control unit transmits and receives chat information via a network and causes the chat information to be displayed on a display unit, the information linkage method comprising:
the control unit generating a response candidate to received chat information and plausibility of the response candidate and displaying the response candidate on the display in accordance with the plausibility.

19. A program for causing a control unit to perform the information linkage method according to claim 16.
